(19) United States
(12) Patent Application Publication
(10) Pub. No.: US 2010/0255140 A1
(43) Pub. Date: Oct. 7, 2010

(54) Plastic Lens Forming Apparatus

(75) Inventor: Hiroshi SHIMIZU, Nagano-ken (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/730,988

(22) Filed: Mar. 24, 2010

(30) Foreign Application Priority Data
Apr. 1, 2009 (JP) 2009-088863

(51) Int. Cl. B29C 41/04; B29C 33/34

(52) U.S. Cl. 425/434

(57) ABSTRACT

A plastic lens forming apparatus which forms a plastic lens having a longitudinal direction and a lateral direction crossing each other at right angles, includes: a mold into which resin as material of the plastic lens is cast, wherein the mold has a pair of mold parts disposed opposed to each other and having a cavity between the mold parts, and a tape wound around the outer circumferential surfaces of the mold parts, and each of the mold parts has a special shape which has a longitudinal portion corresponding to the longitudinal direction of the plastic lens and a lateral portion corresponding to the lateral direction of the plastic lens.

### BACKGROUND

1. Technical Field

The present invention relates to a plastic lens forming apparatus.

2. Related Art

Recently, a plastic lens which is lightweight and has a high degree of transparency is often used as a spectacle plastic lens. A typical method for manufacturing a spectacle plastic lens is a so-called in-mold polymerization which prepares a pair of casting molds having shapes corresponding to the shapes of the eyeball side surface and of the object side surface of the plastic lens, and casts polymeric material compositions into a cavity formed by combining the casting molds to polymerize (harden) the material compositions therein.

As disclosed in JP-A-2000-292313, JP-A-2002-120232, JP-A-2003-53746, and JP-A-2006-215217, for example, a pair of circular casting molds made of glass are disposed opposed to each other, and the outer circumferential surfaces of the molds are fixed by an adhesive tape.

Then, a nozzle is inserted into a cavity formed by the circular casting molds disposed opposed to each other and the adhesive tape, and polymeric material compositions are cast into the cavity. Subsequently, the material compositions are polymerized by heat or ultraviolet radiation to form a plastic lens having a predetermined shape.

After formation of the plastic lens, various surface processes such as a hard coat process and an anti-reflection process are applied to the surface of the plastic lens. Then, the plastic lens is cut into a shape corresponding to a spectacle frame by so-called edging process.

According to this plastic lens manufacturing method, however, a large amount of cutting scraps are produced by the edging process in the cutting step. Since the polymerized plastic lens as crosslinked material cannot be recycled, the great quantity of cutting scraps are only thrown away.

Thus, the problem of the high manufacturing cost arises from this method. Particularly in recent years, a peculiar monomer has been used in many cases with increase in the refractive index of the plastic lens. In this case, the manufacture cost further rises, thereby making the problem more serious. Moreover, disposal of the large amount of cutting scraps increases environmental load.

### SUMMARY

It is an advantage of some aspects of the invention to provide a plastic lens forming apparatus capable of reducing the manufacturing cost of a plastic lens and decreasing environmental load.

A plastic lens forming apparatus which forms a plastic lens having a longitudinal direction and a lateral direction crossing each other at right angles according to an aspect of the invention includes a mold into which resin as material of the plastic lens is cast. The mold has a pair of mold parts disposed opposed to each other and having a cavity between the mold parts, and a tape wound around the outer circumferential surfaces of the mold parts. Each of the mold parts has a special shape which has a longitudinal portion corresponding to the longitudinal direction of the plastic lens and a lateral portion corresponding to the lateral direction of the plastic lens.

According to this structure, the special shape mold having the longitudinal direction and the lateral direction is used. Thus, the capacity of the cavity becomes smaller than that of a circular mold in the plan view. For example, for manufacturing an elliptic plastic lens, a cavity having a radius longer than the length of the plastic lens in the longitudinal direction needs to be formed when the circular mold is used. However, when the special shape mold is used, a cavity of the dimensions similar to the lengths of the plastic lens in the longitudinal direction and the lateral direction is only required.

In this case, the amount of the material used for producing the plastic lens is reduced, and thus the manufacturing cost of the plastic lens is lowered. Moreover, reduction of the amount of material waste thus achieved decreases environmental load.

It is preferable that the plastic lens forming apparatus further includes a tape winding device which winds the tape around the outer circumferential surfaces of the pair of the mold parts. The winding device includes a rotating unit which rotates the pair of the mold parts, a tape feeding unit which feeds the tape toward the pair of the mold parts attached to the rotating unit, and a plurality of tape pressing rolls which presses the tape fed toward the pair of the mold parts against the outer circumferential surfaces of the pair of the mold parts. The tape pressing rolls are separately disposed with the pair of the mold parts interposed between the tape pressing rolls and shifted close to and away from each other in such a manner as to press the outer circumferential surfaces of the pair of the mold parts.

According to this structure, the tape pressing rolls shift close to and away from the rotation center of the special shape mold. Thus, even when the distance between the rotation center and the outer circumferential surface of the special shape mold continuously varies due to the different lengths of the special shape mold in the longitudinal direction and the lateral direction during rotation of the special shape mold, the tape pressing rolls continuously contact the outer circumferential surface of the special shape mold in accordance with the varying distance.

Accordingly, the tape is continuously pressed against the outer circumferential surface of the special shape mold by the tape pressing rolls, and thus the tape can be securely affixed to the outer circumferential surface of the special shape mold.

It is preferable that the tape feeding unit reciprocates along a line segment parallel with a line segment connecting a winding start position of the tape and the rotation centers of the pair of the mold parts such that the winding start position of the tape wound around the outer circumferential surfaces of the pair of the mold parts attached to the rotating unit can be fixed.

According to this structure, the tape feeding unit follows the movements of the tape pressing rolls close to and away from each other when the tape is fed from the tape feeding unit and affixed to the outer circumferential surface of the special shape mold.

In this case, the position of the tape connecting the tape feeding unit and the outer circumferential surface of the special shape mold is maintained in a constant direction (constant angle).

Thus, the tension of the affixed tape is maintained at a constant tension, and the angle formed by the tape and the outer circumferential surface of the special shape mold is maintained at a constant angle. In this condition, there are no possibilities of unevenness in the affixation of the tape caused by the change of the tension, or shift of the tape from the outer circumferential surface of the special shape mold due to the non-uniform affixing angle, for example.

Accordingly, the tape can be more securely affixed to the outer circumferential surface of the special shape mold with more uniform affixation in this structure.

It is preferable that the mold having the special shape has a casting hole at a position corresponding to the longitudinal direction of the mold when a concave lens is formed, and that the mold having the special shape has a casting hole at a position corresponding to the lateral direction of the mold when a convex lens is formed.

According to this structure, the casting hole is formed at a position corresponding to the longitudinal direction when a concave lens is produced, and at a position corresponding to the lateral direction when a convex lens is produced. In this case, the position at which the casting hole is formed corresponds to the thick portion of the plastic lens.

Thus, when a casting needle is used to cast the material of the plastic lens into the cavity, for example, the casting needle can be easily inserted through the casting hole.

Accordingly, working efficiency improves with enhanced easiness for casting the material of the plastic lens into the cavity, and the plastic lens can be manufactured without difficulty even when the plastic lens to be produced is thin.

### BRIEF DESCRIPTION OF THE DRAWINGS

The invention will be described with reference to the accompanying drawings, wherein like numbers reference like elements.

FIG. 1 is a plan view illustrating an external shape of a plastic lens according to an embodiment.

FIG. 2A is a cross-sectional view of a concave lens taken along a line A-A in FIG. 1, and FIG. 2B is a cross-sectional view of the concave lens taken along a line B-B in FIG. 1.

FIG. 3A is a cross-sectional view of a convex lens taken along the line A-A in FIG. 1, and FIG. 3B is a cross-sectional view of the convex lens taken along the line B-B in FIG. 1.

FIG. 4A is a plan view of a special shape mold according to the embodiment, and FIG. 4B is a cross-sectional view of the special shape mold according to the embodiment.

FIGS. 5A through 5C schematically illustrate a plastic lens forming method according to the embodiment.

FIGS. 6A and 6B schematically illustrate the plastic lens forming method according to the embodiment.

FIG. 7 schematically illustrates a method for centering the special shape mold according to the embodiment.

FIG. 8 schematically illustrates a device for affixing a tape on the outer circumferential surface of the special shape mold according to the embodiment.

FIG. 9 schematically illustrates a method for casting plastic lens material into the special shape mold (concave lens) according to the embodiment.

FIG. 10 schematically illustrates a method for casting plastic lens material into the special shape mold (convex lens) according to the embodiment.

### DESCRIPTION OF EXEMPLARY EMBODIMENT

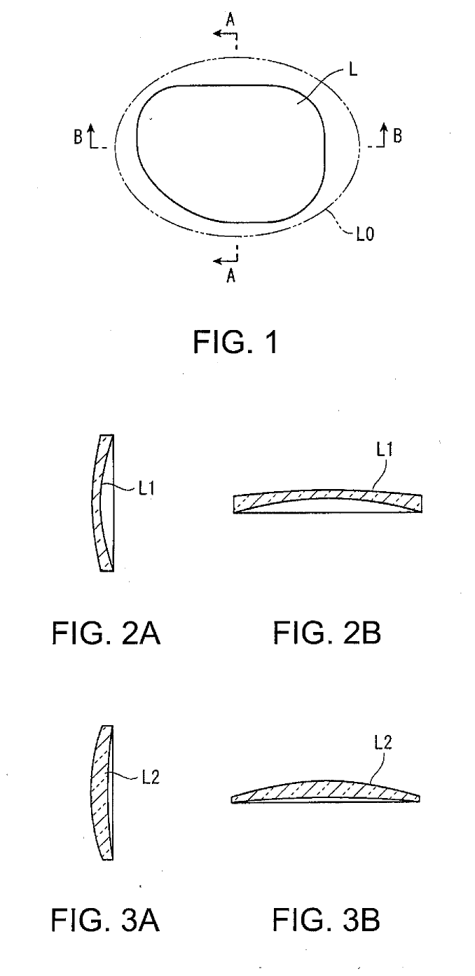

A plastic lens according to an embodiment of the invention is hereinafter described with reference to FIGS. 1 through 3B.

FIG. 1 is a plan view illustrating the external shape of the plastic lens in this embodiment. FIG. 2A is a cross-sectional view of a concave lens taken along a line A-A in FIG. 1, and FIG. 2B is a cross-sectional view of the concave lens taken along a line B-B in FIG. 1. FIG. 3A is a cross-sectional view of a convex lens taken along the line A-A in FIG. 1, and FIG. 3B is a cross-sectional view of the convex lens taken along the line B-B in FIG. 1.

As illustrated in FIG. 1, a plastic lens L0 manufactured according to this embodiment has an elliptic shape slightly larger than the external shape of a spectacle plastic lens L. The spectacle plastic lens L can be produced by cutting and grinding the plastic lens L0.

In the figures, the line A-A corresponds to the lateral direction, and the line B-B corresponds to the longitudinal direction.

As illustrated in FIGS. 2A and 2B and FIGS. 3A and 3B, a concave lens L1 and a convex lens L2 can be formed as the plastic lens L0 in this embodiment.

The concave lens L1 becomes a spectacle plastic lens for a shortsighted person, for example. In this case, the end of the outer circumferential surface of the spectacle plastic lens L (FIG. 1) in the longitudinal direction is thicker than the end of the outer circumferential surface of the lateral cross section.

On the other hand, the convex lens L2 becomes a, spectacle plastic lens for a farsighted person, for example. In this case, the end of the outer circumferential surface of the spectacle plastic lens L (FIG. 1) in the lateral direction is thicker than the end of the outer circumferential surface of the longitudinal cross section.

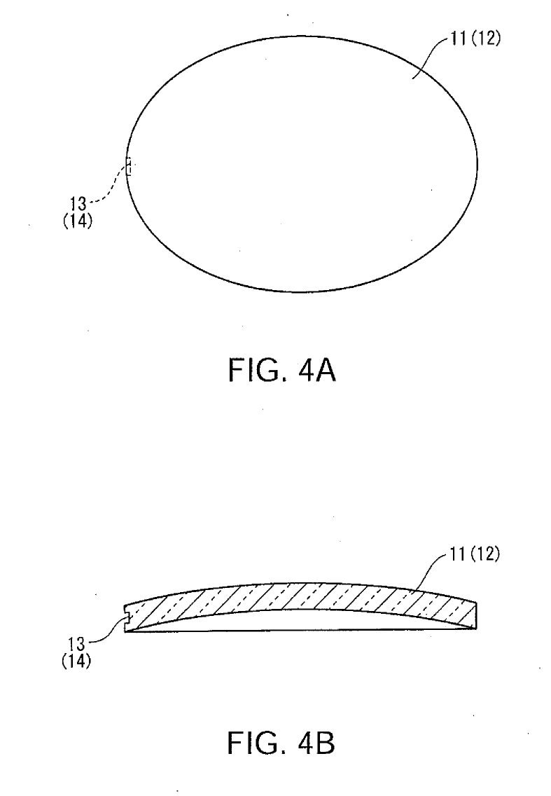

A mold used in this embodiment is now explained with reference to FIGS. 4A and 4B.

FIG. 4A is a plan view of the mold in this embodiment, and FIG. 4B is a cross-sectional view of the mold in this embodiment.

As illustrated in FIGS. 4A and 4B, a first mold 11 is a glass mold having an elliptic shape in the plan view, and a notch 13 is formed at a part of the outer circumferential surface of the first mold 11.

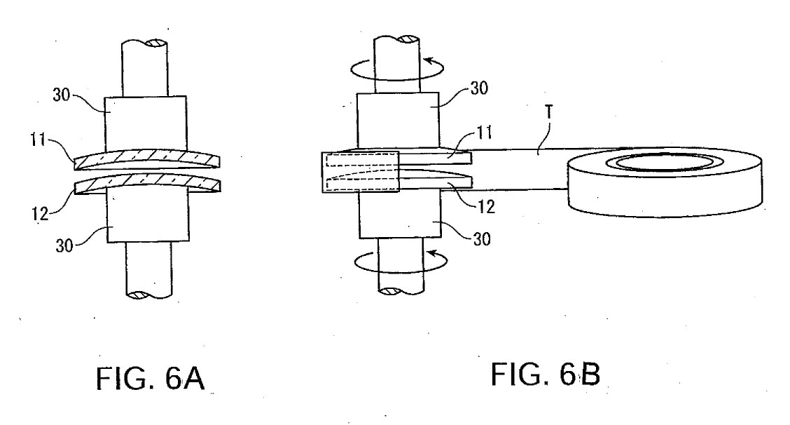

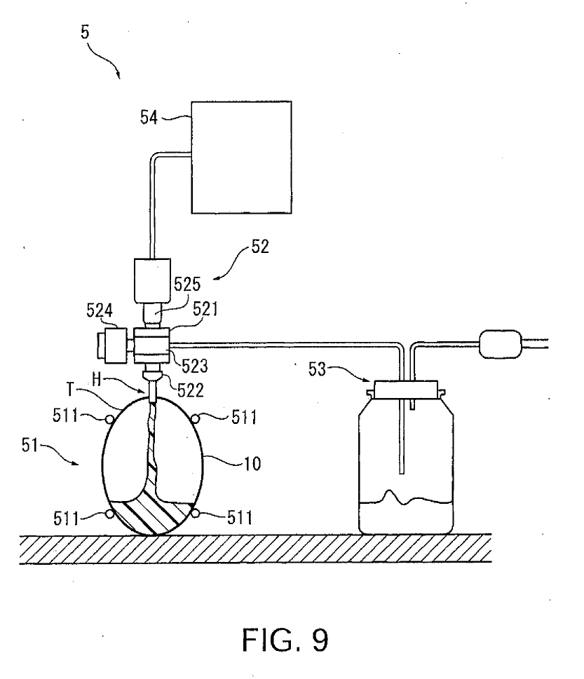

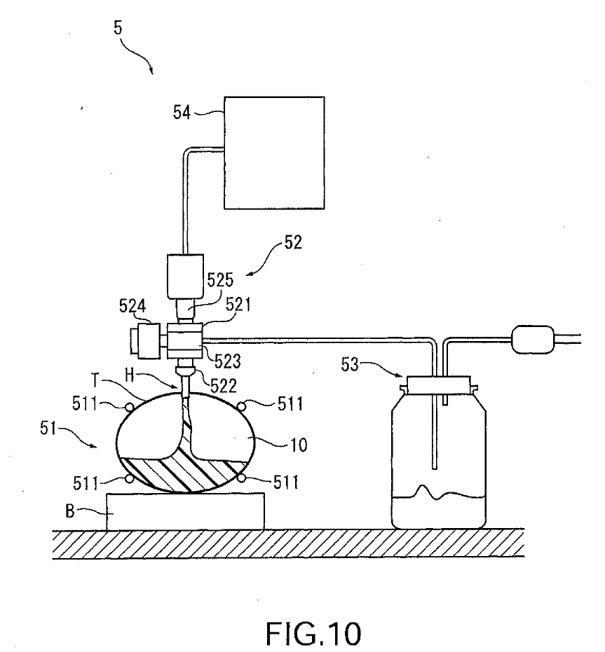

A second mold 12 has a curved surface having an R (radius) different from that of the first mold 11. A special shape mold 10 (see FIGS. 9 and 10) having a cavity is produced by disposing the pair of the first mold 11 and the second mold 12 opposed to each other, and affixing a tape T on the outer circumferential surfaces of the first and second molds 11 and 12 (see FIGS. 6D and 6E).

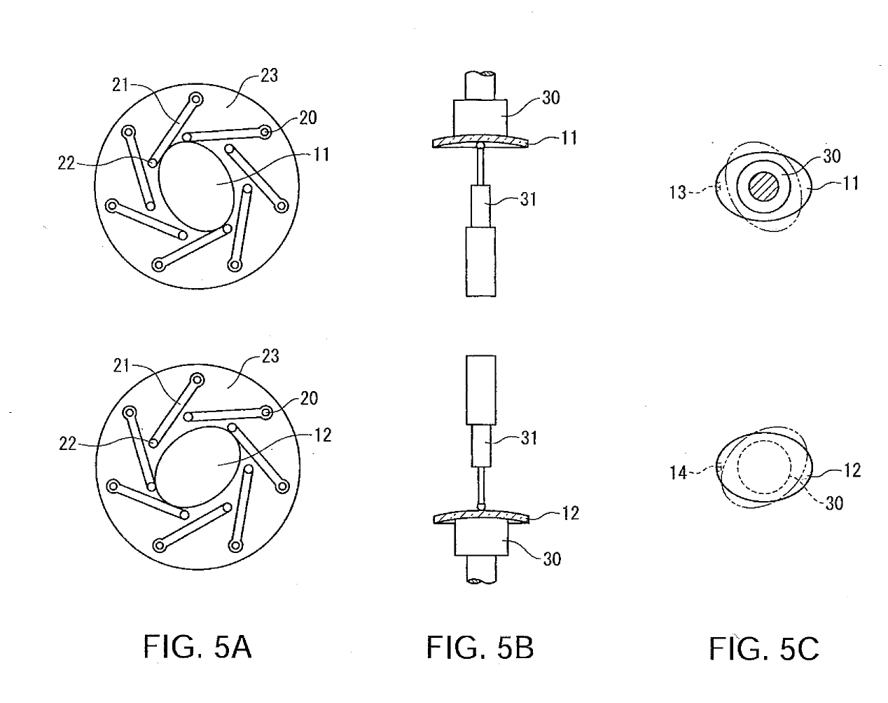

A plastic lens manufacturing apparatus according to this embodiment is now described with reference to FIGS. 5A through 10.

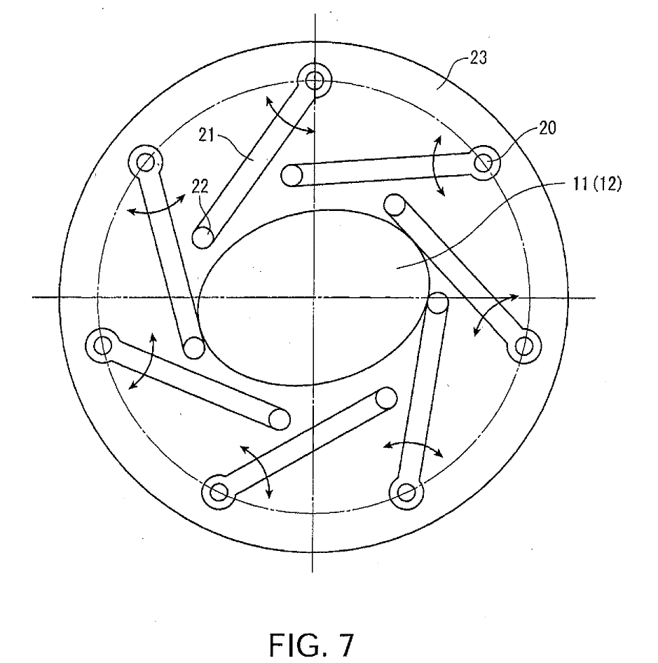

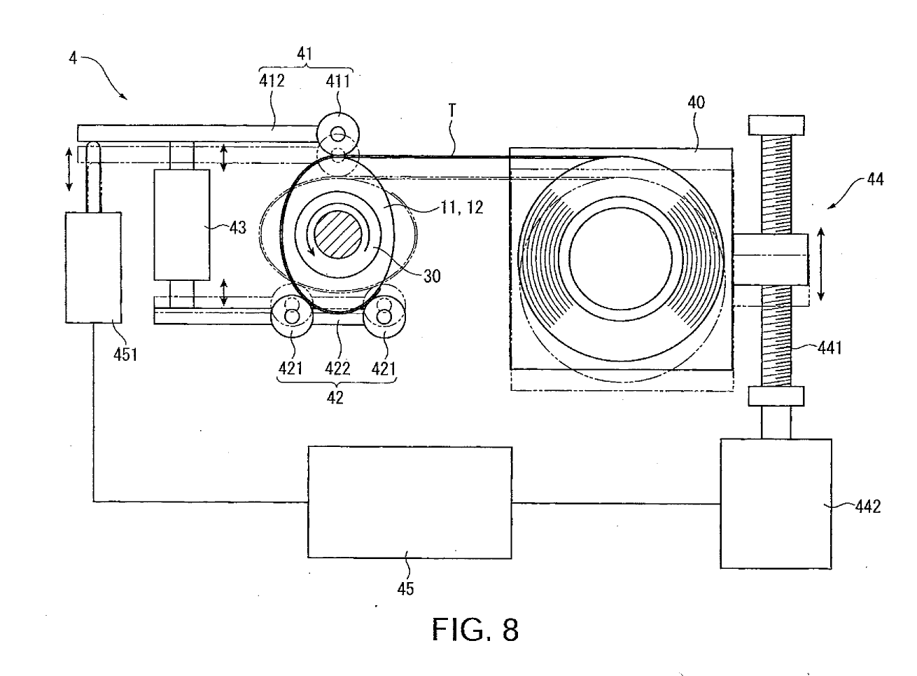

FIGS. 5A through 5C schematically illustrate a plastic lens forming method in this embodiment. FIGS. 6D and 6E also schematically illustrate the plastic lens forming method in this embodiment. FIG. 7 schematically illustrates a device for centering the special shape mold in this embodiment. FIG. 8 schematically illustrates a device for affixing a tape on the outer circumferential surface of the special shape mold in this embodiment.

As illustrated in FIGS. 5A and 7, a seven-claw centering chuck is used for centering the first mold 11 and the second mold 12 in this embodiment. In the figures, centering devices for both the first mold 11 and the second mold 12 are shown. As will be described later, the centering devices are used to hold the centers of the first mold 11 and the second mold 12 by holding members 30.

Each of the centering devices has rotation shafts 20 at seven positions divided at equal intervals in the circumferential direction, levers 21 attached to the respective rotation shafts 20, and positioning pins 22 provided at the respective tips of the levers 21. The rotation shafts 20 are attached to a rough positioning table 23 via bearings.

Pulleys are further provided below the rotation shafts 20 and connected with a chuck open/close drive device via a timing belt.

Thus, the positioning pins 22 move in synchronization with the operation of the chuck open/close drive device to center the first mold 11 and the second mold 12.

The method for centering is not limited to the method using the chuck but may be a method using a plate which has a step corresponding to the outside diameter of the spectacle plastic lens.

As illustrated in FIG. 5B, each of the curved surfaces of the first mold 11 and the second mold 12 where a cavity is not formed is held by the holding member 30. Also, a measuring device 31 for measuring the sizes of the first mold 11 and the second mold 12 is attached to the opposite curved surface of each of the first and second molds 11 and 12 to measure the sizes and shapes of the first and second molds 11 and 12 necessary for producing the plastic lens L0 (FIG. 1).

The detailed measuring, steps are shown in JP-A-2000-292313.

Then, each direction of the first mold 11 and the second mold 12 is determined as illustrated in FIG. 5C. In this case, the respective directions of the first and second molds 11 and 12 held by the holding members 30 are adjusted by rotating the holding members 30 after the sizes and shapes of the first and second molds 11 and 12 are measured.

In this case, the directions are controlled by a not-shown sensor recognizing the notches 13 and 14 formed on the first mold 11 and the second mold 12. The sensor used herein is a CCD camera or the like capable of determining the directions by identifying the notches 13 and 14 through image processing.

Then, the first mold 11 and the second mold 12 held by the holding members 30 are disposed opposed to each other as illustrated in FIG. 6D.

In this case, the first mold 11 and the second mold 12 are positioned opposed to each other such that an appropriate cavity for producing the predetermined plastic lens L0 (see FIG. 1) can be formed based on the size measurement (see FIG. 55) and the direction determination (see FIG. 5C).

Subsequently, the tape T is affixed to the outer circumferential surfaces of the first mold 11 and the second mold 12 opposed to each other as illustrated in FIG. 6E.

The details of the device for affixing the tape T are now discussed with reference to FIG. 8.

As illustrated in FIG. 8, a tape winding device 4 includes a tape feeder 40 as a tape feeding unit for supplying the tape T, a first roller 41 and a second roller 42 as tape pressing rolls disposed opposed to the outer circumferential surfaces of the first mold 11 and the second mold 12 in such positions that the tape T supplied from the tape feeder 40 is sandwiched between the first roller 41 and the outer circumferential surfaces of the first and second molds 11 and and between the second roller 42 and the outer circumferential surfaces of the first and second molds 11 and 12, a roller controlling mechanism 43 for controlling the relative positions of the first roller 41 and the second roller 42 in accordance with the change in the distance between the rotation center and the outer circumferential surfaces of the first and second molds 11 and 12 produced by the different lengths of the first and second molds 11 and 12 in the longitudinal direction and the lateral direction by the rotations of the first and second molds 11 and 12, a feeder controlling mechanism 44 for controlling the position of the tape feeder 40 in accordance with the rotations of the first and second molds 11 and 12, and a not-shown rotation drive mechanism for rotating the holding members 30 in one direction (anticlockwise direction in FIG. 8).

The tape feeder 40 supplies the tape T between the first roller 41 and the first and second molds 11 and 12. An adhesive is provided on the outer circumferential surface of the tape T facing the first and second molds 11 and 12. Thus, the tape T pressed against the outer circumferential surfaces of the first and second molds 11 and 12 by the first roller 41 is affixed to the outer circumferential surfaces of the first and second molds 11 and 12 and sent in this condition.

The first roller 41 has a roller main body 411 made of hard rubber, and a frame 412 for supporting the roller main body 411 such that the roller main body 411 can rotate.

The second roller 42 disposed opposed to the first roller 41 with the first and second molds 11 and 12 interposed between the first and second roller 41 and 42 has a pair of roller main bodies 421 made of hard rubber, and a frame 422 for supporting the roller main bodies 421 such that the roller main bodies 421 can rotate. The roller main bodies 421 press the tape T against the outer circumferential surfaces of the first and second molds 11 and 12.

The roller controlling mechanism 43 is connected with the ends of the frames 412 and 422.

The roller controlling mechanism 43 has a spring, a pneumatic mechanism, or a hydraulic mechanism to shift the first roller 41 and the second roller 42 close to or away from the rotation centers of the first mold 11 and the second mold 12.

The feeder controlling mechanism 44 as a unit for shifting the tape feeder 40 in the direction orthogonal to the direction of supplying the tape T includes a ball screw 441 and a motor 442. The motor 442 is connected with a controller 45 to control the supply position of the tape feeder 40 according to signals supplied from the controller 45.

The controller 45 has a displacement detecting unit 451 which detects displacement produced by the roller controlling mechanism 43 and transmits the detected displacement to the controller 45 as feedback data.

A resin casting device 5 is now explained with reference to FIGS. 9 and 10.

FIG. 9 schematically illustrates a method for casting plastic lens material into the special shape mold (concave lens) in this embodiment. FIG. 10 schematically illustrates a method for casting plastic lens material into the special shape mold (convex lens) in this embodiment.

As illustrated in FIG. 9, the resin casting device 5 includes a special shape mold attachment unit 51, a supply unit 52, a material storage unit 53, and a material supply device 54.

The special shape mold attachment unit 51 has a plurality of mold pressing members 511 which hold the special shape mold 10 produced by winding the tape T around the outer circumferential surfaces of the first mold 11 and the second mold 12.

The special shape mold 10 is a mold used for manufacturing the concave lens L1 (see FIGS. 2A and 2B).

A casting hole H through which resin material is cast is formed on the tape T at the end of the outer circumferential surface of the special shape mold 10 in the longitudinal direction. The casting hole H may be formed either after the special shape mold 10 is held by the mold pressing members 511 and attached to the special shape mold attachment unit 51, or before the special shape mold 10 is attached to the special shape mold attachment unit 51.

The supply unit 52 casts resin material into the cavity of the special shape mold 10 attached to the special shape mold attachment unit 51, and sucks resin material having overflowed the casting hole H of the special shape mold 10 for removal.

The supply unit 52 includes a supply unit main body 521, a casting needle 522 connected with the supply unit main body 521, a liquid discharge portion 523 connected with the supply unit main body 521, a suction sensor 524 connected with the supply unit main body 521, and a material supply portion 525 connected with the supply unit main body 521.

The material storage unit 53 stores resin material having overflowed the casting hole H of the special shape mold 10.

The material supply device 54 supplies resin material to the supply unit 52.

The special shape mold 10 shown in FIG. 10 is placed on a pedestal B, and the casting hole H through which resin material is cast is formed on the tape T at the end of the outer circumferential surface of the special shape mold 10 in the lateral direction.

The special shape mold 10 in FIG. 10 is a mold used for manufacturing the convex lens L2 (see FIGS. 3A and 3B), and other structure in the figure is similar to that in FIG. 9.

As apparent from above, the following advantages can be provided in this embodiment.

(1) According to this embodiment, the elliptic special shape mold 10 is used. Thus, the capacity of the cavity becomes smaller than that of a circular mold.

More specifically, in case of the circular mold in the plan view, a cavity having a radius equal to or longer than the length of the plastic lens L0 in the longitudinal direction needs to be formed. However, in case of the special shape mold 10, a cavity of the dimensions similar to the lengths of the plastic lens L0 in the longitudinal direction and the lateral direction is only required.

In this case, the amount of the material used for producing the plastic lens L0 is reduced, and thus the manufacturing cost of the spectacle plastic lens L is lowered. Moreover, reduction of the amount of material waste thus achieved decreases environmental load.

(2) According to this embodiment, the respective first roller 41 and the second roller 42 shift close to and away from the rotation centers of the first mold 11 and the second mold 12. Thus, even when the distance between the rotation center and the outer circumferential surfaces of the first and second molds 11 and 12 continuously varies due to the different lengths of the first and second molds 11 and 12 in the longitudinal direction and the lateral direction during rotation of the first and second molds 11 and 12, the first roller 41 and the second roller 42 continuously contact the outer circumferential surfaces of the first and second molds 11 and 12 in accordance with the varying distance.

Accordingly, the tape T is continuously pressed against the outer circumferential surfaces of the first mold 11 and the second mold 12 by the first roller 41 and the second roller 42, and thus the tape T can be securely affixed to the outer circumferential surfaces of the first mold 11 and the second mold 12.

(3) According to this embodiment, the tape feeder 40 follows the movements of the first roller 41 and the second roller 42 close to and away from each other when the tape T is fed from the tape feeder 40 and affixed to the outer circumferential surfaces of the first mold 11 and the second mold 12.

In this case, the direction of the tape T connecting the tape feeder 40 and the outer circumferential surfaces of the first mold 11 and the second mold 12 is maintained in a constant direction (constant angle).

Thus, the tension of the affixed tape T is maintained at a constant tension, and the angle formed by the tape T and the outer circumferential surfaces of the first mold 11 and the second mold 12 is maintained at a constant angle. In this condition, there are no possibilities of unevenness in the affixation of the tape T caused by the change of the tension, or shift of the tape T from the outer circumferential surfaces of the first and second molds 11 and 12 due to the non-uniform affixing angle.

Accordingly, the tape T can be more securely affixed to the outer circumferential surfaces of the first mold 11 and the second mold 12 with more uniform affixation in this embodiment.

(4) According to this embodiment, the casting hole H is formed at a position corresponding to the longitudinal direction when the concave lens L1 is produced, and at a position corresponding to the lateral direction when the convex lens L2 is produced. In this case, the position at which the casting hole H is formed corresponds to a thick portion of the plastic lens L0.

Thus, the casting needle 522 can be easily inserted through the casting hole H at the time of casting of the material of the plastic lens L0 into the cavity.

Accordingly, working efficiency improves with enhanced easiness for casting the material of the plastic lens L0 into the cavity, and the plastic lens L0 can be manufactured without difficulty even when the plastic lens L0 to be produced is thin.

(5) According to this embodiment, the notches 13 and 14 are formed on the outer circumferential surfaces of the first mold 11 and the second mold 12, respectively. Thus, the directions of the first mold 11 and the second mold 12 can be easily recognized and easily determined.

(6) According to this embodiment, the movements of the first roller 41 and the second roller 42 close to and away from each other are detected by the displacement detecting unit 451, and transmitted to the controller 45 such that the motor 442 can follow the movements of the first and second rollers 41 and 42.

Thus, the tape feeder 40 can follow the movements of the first roller 41 and the second roller 42 with high accuracy by the simple structure.

The invention is not limited to the embodiment described herein but may be practiced otherwise without departing from the scope of the invention. As such, various changes and improvements including the following modifications may be made.

According to this embodiment, the elliptic special shape mold 10 is used. However, the shape of the mold may be other shapes such as rectangular and triangular shapes as long as the shapes agree with the shape of the lens to be finally obtained.

According to this embodiment, the notches 13 and 14 are recognized by the image processing using a CCD camera or the like. However, the notches 13 and 14 may be physically recognized by attaching a recognition member capable of recognizing the notches 13 and 14 to the outer circumferential surfaces of the first mold 11 and the second mold 12, for example.

According to this embodiment, the displacement detecting unit 451 is constituted by a physical unit. However, the displacement may be detected by an optical unit using laser.

The technology according to the invention is applicable not only to manufacture of the spectacle plastic lens but also to methods for manufacturing optical plastic lenses such as dustproof glass, dustproof crystal, condenser plastic lens, and prism.

The entire disclosure of Japanese Patent Application No: 2009-088863, filed Apr. 1, 2009 is expressly incorporated by reference herein.

What is claimed is:

1. A plastic lens forming apparatus which forms a plastic lens having a longitudinal direction and a lateral direction crossing each other at right angles, comprising:
a mold into which resin as material of the plastic lens is cast,
wherein
the mold has a pair of mold parts disposed opposed to each other and having a cavity between the mold parts, and a tape wound around the outer circumferential surfaces of the mold parts, and
each of the mold parts has a special shape which has a longitudinal portion corresponding to the longitudinal direction of the plastic lens and a lateral portion corresponding to the lateral direction of the plastic lens.

2. The plastic lens forming apparatus according to claim 1, further comprising:
a tape winding device which winds the tape around the outer circumferential surfaces of the pair of the mold parts,
wherein
the winding device includes a rotating unit which rotates the pair of the mold parts, a tape feeding unit which feeds the tape toward the pair of the mold parts attached to the rotating unit, and a plurality of tape pressing rolls which presses the tape fed toward the pair of the mold parts against the outer circumferential surfaces of the pair of the mold parts, and
the tape pressing rolls are separately disposed with the pair of the mold parts interposed between the tape pressing rolls and shifted close to and away from each other in such a manner as to press the outer circumferential surfaces of the pair of the mold parts.

3. The plastic lens forming apparatus according to claim 2, wherein the tape feeding unit reciprocates along a line segment parallel with a line segment connecting a winding start position of the tape and the rotation centers of the pair of the mold parts such that the winding start position of the tape wound around the outer circumferential surfaces of the pair of the mold parts attached to the rotating unit can be fixed.

4. The plastic lens forming apparatus according to claim 1, wherein:
the mold having the special shape has a casting hole at a position corresponding to the longitudinal direction of the mold when a concave lens is formed; and
the mold having the special shape has a casting hole at a position corresponding to the lateral direction of the mold when a convex lens is formed.
